(19) United States
(12) Patent Application Publication
(10) Pub. No.: US 2022/0030588 A1
(43) Pub. Date: Jan. 27, 2022

(54) Resource Allocation for Data Transmission

(71) Applicant: Nokia Technologies Oy, Espoo (FI)

(72) Inventors: Hamidreza SHARIATMADARI, Espoo (FI); Zexian LI, Espoo (FI); Mikko Aleksi UUSITALO, Helsinki (FI)

(21) Appl. No.: 17/311,727

(22) PCT Filed: Dec. 18, 2018
(86) PCT No.: PCT/EP2018/085372

§ 371 Date: Jun. 8, 2021

(51) Int. Cl. H04W 72/04; H04W 28/26; H04L 1/08

(52) U.S. Cl. CPC H04W 72/0426; H04W 28/26; H04L 1/08; H04W 72/0446; H04W 72/042

(57) ABSTRACT

Resource allocation for data transmission. A method includes: detecting a need for a transmission of data from a first user apparatus via a first base station to a second user apparatus via a second base station. In response to detecting the need, requesting backhaul resources for a transmission from the first base station to the second base station. After requesting the backhaul resources, controlling reception of the data from the first user apparatus, and triggering a transmission of the data using the backhaul resources to the second base station for a transmission of the data to the second user apparatus.

### FIELD

Various example embodiments relate to data transmission.

### BACKGROUND

Efficient data transmission requires sophisticated resource allocation, both for deterministic and non-deterministic traffic types.

### BRIEF DESCRIPTION

According to an aspect, there is provided subject matter of independent claims. Dependent claims define some example embodiments.

One or more examples of implementations are set forth in more detail in the accompanying drawings and the description of embodiments.

### LIST OF DRAWINGS

Some example embodiments will now be described with reference to the accompanying drawings, in which

FIG. 1 illustrates an example embodiment of a general architecture of a system for data transmission;

FIG. 2 and FIG. 3 illustrate example embodiments of an apparatus;

FIG. 4 illustrates example embodiments of a method;

FIG. 5 and FIG. 6 illustrate example embodiments of resource allocation for the data transmission; and

FIG. 7 illustrates an example embodiment of a signal sequence chart of the data transmission.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the example embodiments and in the claims, serve to illustrate the example embodiments with reference to the drawings, without limiting it to these examples only.

In the following, different example embodiments will be described using, as an example of an access architecture to which the embodiments may be applied, a radio access architecture based on long term evolution advanced (LTE Advanced, LTE-A) or new radio (NR, 5G), or future cellular technologies (e.g. 6G or the like) without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or Wi-Fi), worldwide interoperability for microwave access (WiMAX), wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures besides those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user apparatuses 100 and 102 configured to be in a wireless connection on one or more communication channels in a cell with an access node (such as (e/g)NodeB) 104 providing the cell. The physical link from the user apparatus 100, 102 to the (e/g)NodeB 104 is called uplink or reverse link and the physical link from the (e/g)NodeB 104 to the user apparatus 100, 102 is called downlink or forward link. It should be appreciated that (e/g)NodeBs or their functionalities may be implemented by using any node, host, server or access point etc. entities suitable for such a usage, for example according to a higher layer split architecture, comprising a central-unit (so-called gNB-CU) controlling one or more distributed units (so-called gNB-DU).

A communications system typically comprises more than one (e/g)NodeB 104 in which case the (e/g)NodeBs 104 may also be configured to communicate with one another through logical interfaces (such Xn/X2) running over links, wired or wireless, designed for the purpose. These interfaces may be used for data and signalling purposes. The (e/g)NodeB 104 is a computing device configured to control the radio resources of communication system it is coupled to. The NodeB 104 may also be referred to as a base station, an access point or any other type of interfacing device including a relay station capable of operating in a wireless environment. The (e/g)NodeB 104 includes or is coupled to transceivers. From the transceivers of the (e/g)NodeB 104, a connection is provided to an antenna unit that establishes bi-directional radio links to user apparatuses 100, 102. The antenna unit may comprise a plurality of antennas or antenna elements (sometimes also referred to as antenna panels, or transmission and reception points, TRP). The (e/g)NodeB 104 is further connected to a core network 106 (CN or next generation core NGC). Depending on the system, the counterpart on the CN side can be a serving gateway (S-GW, routing and forwarding user data packets), packet data network gateway (P-GW), for providing connectivity of user apparatuses 100, 102 to external packet data networks, or mobile management entity (MME), access and mobility function (AMF), etc.

The user apparatus 100, 102 (also called user equipment UE, user terminal, terminal device, subscriber terminal, etc.) illustrates one type of an apparatus to which resources on the air interface are allocated and assigned, and thus any feature described herein with a user apparatus may be implemented with a corresponding apparatus, such as a relay node. An example of such a relay node is a layer 3 relay (self-backhauling relay) towards the base station.

The user apparatus 100, 102 typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that the user apparatus 100, 102 may also be a nearly exclusive uplink only device, of which an example is a camera or video camera loading images or video clips to a network. The user apparatus 100, 102 may also be a device having capability to operate in Internet of Things (IoT) network which is a scenario in which objects are provided with the ability to transfer data over a network without requiring human-to-human or human-to-computer interaction. One technology in the above network may be denoted as narrowband Internet of Things (NB-lot). The user apparatus 100, 102 may also be a device having capability to operate utilizing enhanced machine-type communication (eMTC). The user apparatus 100, 102 may also utilize cloud. In some applications, the user apparatus 100, 102 may comprise a small portable device with radio parts (such as a watch, earphones or eyeglasses) and the computation is carried out in the cloud. The user apparatus 100, 102 (or in some embodiments a layer 3 relay node) is configured to perform one or more of user equipment functionalities. The user apparatus 100, 102 may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE, including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, above 6 GHz-mmWave, possibly using the same radio interfaces but with different parametrization). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is typically fully distributed in the radio and fully centralized in the core network. The low latency applications and services in 5G require to bring the content close to the radio which leads to local break out and mobile edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

In an embodiment, 5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 110 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs 104, the user apparatus 100, 102 may have access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e/g)NodeBs 104 of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs 104 are required to provide such a network structure.

For fulfilling the need for improving the deployment and performance of communication systems, the concept of “plug-and-play” (e/g)NodeBs 104 has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). An HNB Gateway (HNB-GW), which is typically installed within an operator's network may aggregate traffic from a large number of HNBs back to a core network.

As mentioned, radio access network may be split into two logical entities called Central Unit (CU) 108 and Distributed Unit (DU) 104. In prior art, both CU and DU supplied by the same vendor. Thus, they are designed together and interworking between the units is easy. The interface between CU and DU is currently being standardized by 3GPP and it is denoted F1 interface. Therefore, in the future the network operators may have the flexibility to choose different vendors for CU and DU. Different vendors may provide different failure and recovery characteristics for the units. If the failure and recovery scenarios of the units are not handled in a coordinated manner, it will result in inconsistent states in the CU and DU (which may lead to subsequent call failures, for example). Thus, there is a need to enable the CU and DU from different vendors to coordinate operation to handle failure conditions and recovery, considering the potential differences in resiliency capabilities between the CU and DU.

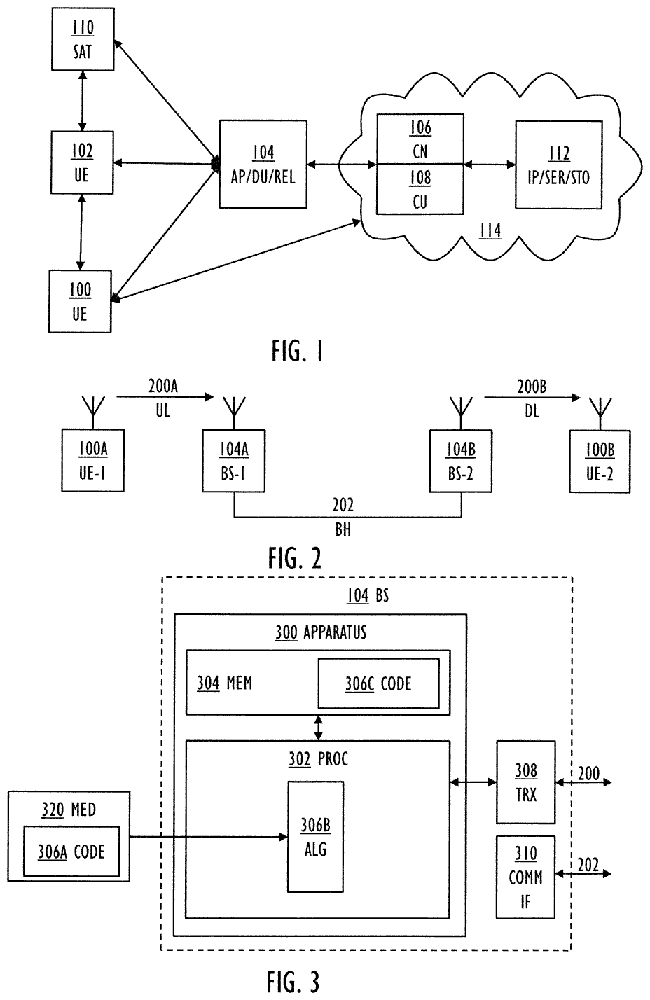

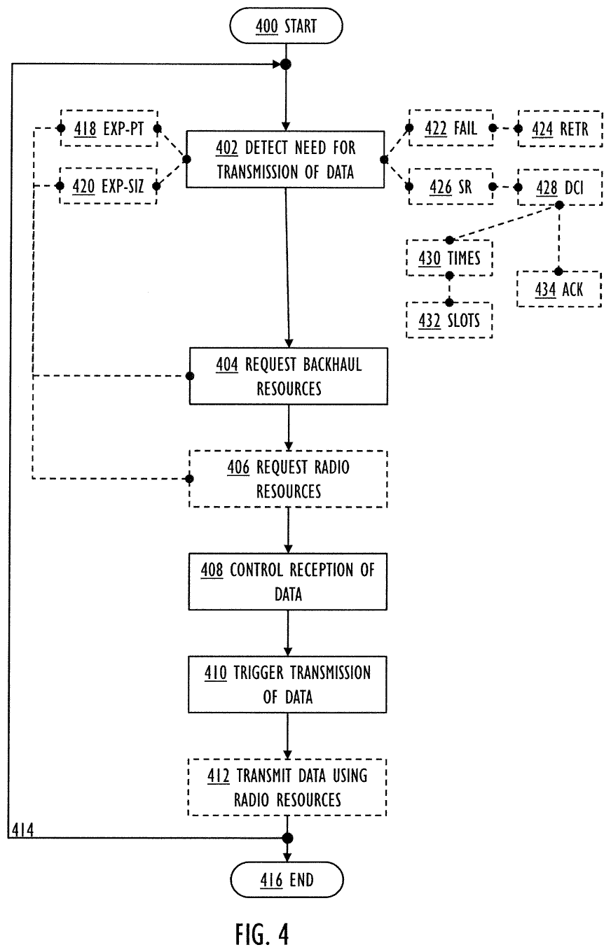

Let us study simultaneously both FIG. 2 and FIG. 3, which illustrate example embodiments of an apparatus 300, and FIG. 4, which illustrates example embodiments of a method performed by the apparatus 300.

The basic operation is illustrated in FIG. 2: transmission of data from a first user apparatus 100A via a first base station 104A to a second user apparatus 100B via a second base station 104B.

In an example embodiment, the apparatus 300 is the first base station 104A. In an example embodiment, the apparatus 300 is a part of the first base station 104A, and/or a part of a control apparatus (in 106/108/114) for the first base station 104A.

In an example embodiment, the apparatus 300 is a circuitry.

In an example embodiment, the apparatus 300 is a combination of a processor, memory and software.

In an example embodiment of FIG. 3, the apparatus 300 comprises one or more processors 302, and one or more memories 304 including computer program code 306C. The one or more memories 304 and the computer program code 306B, 306C are configured to, with the one or more processors 302, cause the performance of the apparatus 300.

The term ‘processor’ 302 refers to a device that is capable of processing data. Depending on the processing power needed, the apparatus 300 may comprise several processors 302 such as parallel processors or a multicore processor. When designing the implementation of the processor 302, a person skilled in the art will consider the requirements set for the size and power consumption of the apparatus 300, the necessary processing capacity, production costs, and production volumes, for example. The processor 302 and the memory 304 may be implemented by an electronic circuitry.

A non-exhaustive list of implementation techniques for the processor 302 and the memory 304 includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

The term ‘memory’ 304 refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

The computer program code 306A, 306B, 306C may be implemented by software. In an example embodiment, the software may be written by a suitable programming language, and the resulting executable code 306C may be stored on the memory 304 and run by the processor 302.

The one or more memories 302 and the computer program code 306B, 306C are configured to, with the one or more processors 302, cause the apparatus 300 at least to perform an algorithm 306B illustrated in FIG. 4 as the method. As explained above, the functionality of the algorithm 306B may be realized by suitably programmed and executed software or by appropriately designed hardware.

In an example embodiment, the apparatus 300 comprises means for causing the apparatus 300 to perform the method.

The operations are not strictly in chronological order in FIG. 4, and some of the operations may be performed simultaneously or in an order differing from the given ones. Other functions may also be executed between the operations or within the operations and other data exchanged between the operations. Some of the operations or part of the operations may also be left out or replaced by a corresponding operation or part of the operation. It should be noted that no special order of operations is required, except where necessary due to the logical requirements for the processing order.

The method starts in 400.

In 402, a need for a transmission of data from a first user apparatus 100A via a first base station 104A to a second user apparatus 100B via a second base station 104B is detected. The data may be user plane data, for example, such as video data, image data, alphanumeric data, etc.

The fifth generation (5G) of wireless systems will accommodate a wide range of services. The main considered services include enhanced mobile broadband (eMBB), massive machine-type communications (mMTC), and ultra-reliable low-latency communications (URLLC). URLLC is a new usage scenario that enables emerging new applications from various verticals, like industrial automations, autonomous driving, vehicular safety, e-health services. The initial target for 3GPP Rel-15 NR is providing the connectivity with reliability corresponding to block error rate (BLER) of 10⁻⁵ and up to 1 ms U-Plane latency in the future networks. However, more stringent requirements are under discussion in Rel-16 to support other more demanding applications, such as wireless industrial Ethernet including time sensitive networking.

In response to detecting 402 the need, in 404, backhaul resources 202 for a transmission from the first base station 104A to the second base station 104B are requested.

In an example embodiment in 406, radio resources 200B for a transmission from the second base station 104B to the second user apparatus 100B are also requested.

The backhaul resources 202 between the first base station 104A and the second base station 104B may utilize suitable network technology such as optical fibre, wiring, radio link etc. and it may operate over private and/or public networks. The backhaul resources 202 may include more network nodes other than the first base station 104A and the second base station 104B. The radio resources 200A, 200B may utilize the radio technologies explained with reference to FIG. 1.

In an example embodiment, the means of the apparatus 300 are configured to cause the apparatus 300 to perform: defining 418 an expected point in time when the data for the transmission is ready, and requesting 404, 406 the backhaul resources 202 and the radio resources 200B based on the expected point in time.

In an alternative or additional example embodiment, the means of the apparatus 300 are configured to cause the apparatus 300 to perform: defining 420 an expected size of the data for the transmission, and requesting 404, 406 the backhaul resources 202 and the radio resources 200B based on the expected size.

After requesting 404 the backhaul resources 202 (and optionally the radio resources 200B), in 408, reception of the data from the first user apparatus 100A is controlled, and, in 410, a transmission of the data using the backhaul resources 202 is triggered to the second base station 104B for a transmission 412 of the data (using the radio resources 200B) to the second user apparatus 1008.

The described sequence 402-404(-406)-408-410 implements a proactive resource allocation for achieving low-latency communications. The proposed scheme is applicable to both deterministic and non-deterministic traffic types. The method ends in 416, or is looped 414 back for processing the next data transmission need. Optional example embodiments 418-434 will be described later.

In an example embodiment, the functionality of the apparatus 300 may be designed by a suitable hardware description language (such as Verilog or VHDL), and transformed into a gate-level netlist (describing standard cells and the electrical connections between them), and after further phases the chip implementing the functionality of the processor 302, memory 304 and the code 306C of the apparatus 300 may be fabricated with photo masks describing the circuitry.

In an example embodiment, the apparatus 300 comprises: detection circuitry configured to detecting 402 a need for a transmission of data from a first user apparatus 100A via a first base station 104A to a second user apparatus 100B via a second base station 104B; a requesting circuitry configured to request 404 backhaul resources 202 for a transmission from the first base station 104A to the second base station 104B, in response to detecting 402 the need; and a controlling circuitry configured to control 408 reception of the data from the first user apparatus 100A, and to trigger 410 a transmission of the data using the backhaul resources 202 to the second base station 104B for a transmission 412 of the data (using the radio resources 200B) to the second user apparatus 1008, after requesting 404 the backhaul resources 202 and optionally the radio resources 200B.

As shown in FIG. 3, the base station 104 also comprises transceiver circuitry 308 configured to implement the data transmission 200, and communication interface circuitry 310 configured to implement the communication using the backhaul resources 202.

In an example embodiment of FIG. 3, a computer-readable medium 320 comprises computer program code 306A, which, when loaded into one or more processors 302 and executed by the one or more processors 302, causes an apparatus to perform the method of FIG. 4.

The example embodiments of the apparatus 300 and the method of FIG. 4 may be used to enhance the operation of the computer program code 306A. In an example embodiment, the computer program code 306A may be in source code form, object code form, executable file, or in some intermediate form, for example. The computer-readable medium 320, may comprise at least the following: any entity or device capable of carrying computer program code 306A to the apparatus 300, a record medium, a computer memory, a read-only memory, an electrical carrier signal, a telecommunications signal, and a software distribution medium. In some jurisdictions, depending on the legislation and the patent practice, the computer-readable medium 320 may not be the telecommunications signal. In an example embodiment, the computer-readable medium 320 may be a non-transitory computer-readable storage medium.

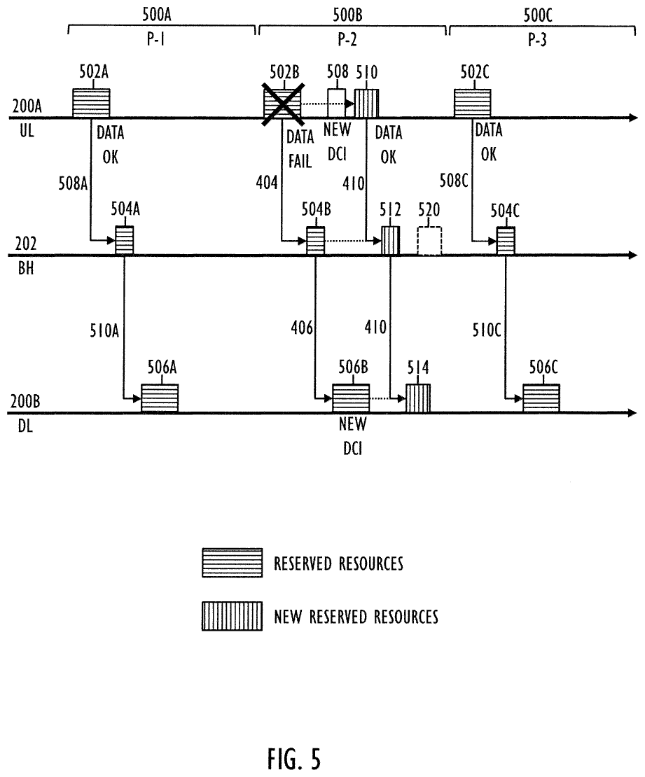

Let us next study FIG. 4 and FIG. 5 illustrating example embodiments of resource allocation for the data transmission.

Semi-persistent scheduling (SPS) has been utilized in LTE to provide efficient data transmissions for the periodic traffic type, such as voice calls. This is achieved by reserving periodic radio resources for the initial data transmissions, in uplink or downlink. In case the initial transmission fails, the first base station 104A provides additional resources and instructs the first UE 100A for data retransmission by sending a downlink control information (DCI). The SPS has been specified in Rel-15 NR as an enabler for URLLC which has been called as “Configure Grant”. It may reduce the communication latency in uplink, as the first UE 100A may start transmitting data without the need to send a scheduling request (SR). In addition, the higher reliability may be achieved, since the first UE 100A does not need to decode a DCI for the initial transmission (For normal operation, the first UE 100A cannot utilize allocated resources if it misses the corresponding DCI). In addition, other elements of the network may be configured according to the SPS traffic to achieve a better performance, for instance, the resources may be also reserved along the path between the first UE 100A and the destination, such as the backhaul links 202. However, this approach does not achieve good performance when the data arrives late, for instance, due to failure in data reception. To address this issue, the example embodiments provide a proactive resource allocation scheme, to provide additional resources when the data arrives late. Also, other suitable scheduling schemes may be used, such as a configured grant of NR.

SPS is mainly developed to reserve radio resources over the radio access network (RAN) in the cellular systems. This is efficient for periodic and deterministic traffic types. The resource reservation is also applicable to wired and optical networks, to achieve very low latency. For instance, TSN (Time Sensitive Network) supports IEEE 802.1Qat stream reservation protocol (SRP) for deterministic traffics, which reserves network resources and advertises streams in packet switched networks over full-duplex Ethernet links. This protocol ensures that the deterministic traffic passes through the network with very low latency.

The SPS may be utilized along the SRP in order to achieve the low-latency communications for deterministic traffic between UEs operating in the cellular mode (shown in FIG. 2). The SPS is applied for uplink 200A and downlink 200B, while the SRP is enabled for the backhaul network 202. The reserved resources may be aligned to achieve very low latency. FIG. 5 illustrates the resource reservations over the RAN and the backhaul network. The performance of SPS and SRP is satisfactory when the data arrives at the expected time, like the first payload 500A and the third payload 500C. Note that reserved 502A, 502C resources for the uplink 200A, reserved resources 504A, 504C for the backhaul 202, and reserved resources 506A, 506C for the downlink 200B may be used in due time as the data is received and decoded successfully in the uplink 200A by the first base station 104A, whereupon it is transferred 508A, 510A, 508C, 510C via the backhaul 202 to the second base station 104B for the downlink 200B transmission.

However, this approach cannot offer low latency if the data arrives late, for instance, due to the failure in delivering the data with the initial transmission attempt, like the second payload 500B. In this case, the first base station 104A needs to allocate additional radio resources 510 for the first UE 100A and send a DCI 508 to trigger the data retransmission. When the first base station 104A decodes the message successfully, it forwards 404, the message to the second base station 104B through the backhaul network 202.

In an example embodiment, the means of the apparatus 300 are configured to cause the apparatus 300 to detect 402 the need by detecting 422 a failed initial transmission of the data.

Without the described example embodiments, the backhaul 202 would treat the delayed message as a normal packet, and apply the best effort policy to deliver it to the second base station 104B. Meanwhile, the reserved resources 200B for the downlink transmission would not be used, as the data has not arrived. When the second base station 104B receives the data, it would allocate additional resources for the second UE 100B and instruct the second UE 100B by sending a DCI 520, and then the data would be transmitted later, between the second payload 500B and the third payload 500C, for example.

However, with the described example embodiments, the proactive resource reservations are enabled in order to achieve low latency for the delayed messages, when the SPS and SRP are applied. The proposed scheme is shown in FIG. 5.

When the first base station 104A identifies that the data from the first UE 100A has failed in the initial transmission round for example due to decoding failure, it triggers the data retransmission 510 by sending a DCI 508 carrying resource grant for packet retransmission.

Meanwhile, the first base station 104A uses the original reserved resources 504B over the backhaul network 202 to send a request to the second base station 104B for reserving new resources 514 for the delayed (retransmitted) message. In addition, the first base station 104A will request new backhaul resources 512 for the retransmitted message. In addition, the first base station 104A may include additional information regarding the expected time instance that the message will be ready for transmission over the backhaul network 202 (which may cover multiple nodes), and it may also optionally consider channel conditions, the employed TTI (Transmission Time Interval), the slot configurations, processing time for retransmission and decoding the message, and/or scheduling policy. Also, the expected message size may be indicated. Accordingly, the backhaul network 202 reserves the new backhaul resources 512 between all involved nodes for the message that arrives later.

If the retransmission fails again, the first base station 104A may utilize the additional reserved resources 512, 514 (provided upon the previous request) for the retransmission to ask for reserving resources for the other retransmission round, if further data retransmission is envisioned.

The backhaul network 202 may also inform the second base station 104B regarding the delayed message, indicating the time instance that the message will be available for it. Hence, the second base station 104B may proactively assign radio resources 514 before the message arrived. The information regarding the allocated resources may be carried using the reserved resources 506B for the initial SPS transmission to achieve higher reliability for delivering the DCI and also reduce the latency.

The second UE 100B may prevent sending ACK/NACK in response to the new DCI, carried over the reserved SPS resources 506B. This may be enabled if there is no uplink slot before the slot in which the delayed data will be carried or such behaviour configured to the UE beforehand.

The second UE 100B may send either an ACK or a NACK in response to the new DCI that it carried over the reserved SPS resources 506B. This may be enabled if an uplink slot is available before the point in time when the delayed transmission will be performed. This helps the second base station 104B to know if the second UE 100B is ready for receiving the delayed data. In case the ACK is not detected, the second base station 1048 retransmits the DCI before or along transmitting the delayed message.

If the second UE 100B is configured for DRX (discontinuous reception) mode, the second base station 104B may ask the second UE 100B not to enter the DRX mode to receive the delayed message.

FIG. 5 suggests that the proposed proactive resource reservation enables delivering the delayed message fast, since additional resources are reserved over the backhaul 202 and the serving second base station 104B for the second UE 1008. In addition, the SPS resources 506B for the downlink 200B are utilized for delivering the DCI, which may achieve a better reliability.

In an example embodiment, the means of the apparatus 300 are configured to cause the apparatus 300 to perform the following sequence: In response to detecting 402 the need, triggering 424 a retransmission procedure of the data, and requesting 404 the backhaul resources 202 so that backhaul resources which have been reserved before detecting 402 the need are used for requesting retransmission backhaul resources and retransmission radio resources 200B for a retransmission so that radio resources which have been reserved before detecting 402 the need are used for transmitting downlink control information to the second user apparatus 100B in order to reserve the retransmission radio resources. After requesting 404 the retransmission backhaul resources 202, controlling 408 reception of the data from the first user apparatus 100A as a retransmission of the data, and triggering 410 the transmission of the data as a retransmission of the data using the retransmission backhaul resources 202 to the second base station 104B for the transmission of the data as a retransmission of the data using the retransmission radio resources to the second user apparatus 1008.

The proposed proactive resource reservations may also be applied to non-deterministic traffic types, to reduce the delay caused by queuing or scheduling. The current resource scheduling for non-deterministic traffic operates as follows: The first UE 100A needs to transmit a scheduling request (SR) to the first base station 104A when it has some data for uplink transmissions. Accordingly, the first base station 104A allocates uplink 200A resources and informs the first UE 100A by sending a DCI. Then, the first UE 100A performs the uplink 200A data transmissions. When the first base station 104A decodes the message successfully, it forwards the message to the second base station 104B to be delivered to the second UE 1008. In an example embodiment, the backhaul network 202 may treat the message as best effort traffic type. When the message is delivered to the second base station 104B, it allocates resources for the downlink 200B transmissions and instructs the second UE 100B to receive the data.

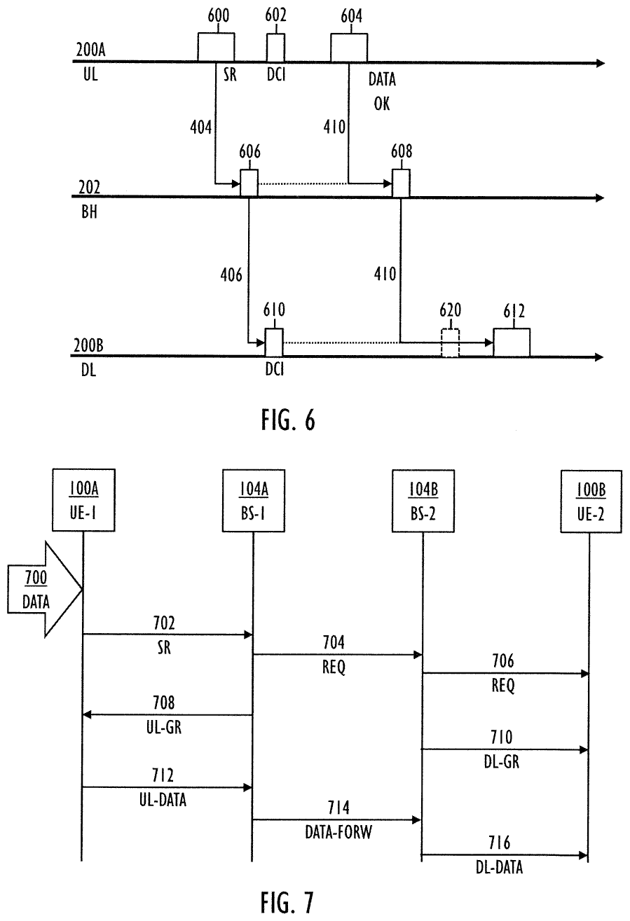

FIG. 6 and FIG. 7 illustrate the implementation of proactive resource reservations for non-deterministic data 700. When the first base station 104A receives 702 an SR 600 it allocates 708 radio resources 604 for the first UE 100A by transmitting downlink control information 602 (within Physical Downlink Control Channel (PDCCH), for example) carrying resource information allocated for the uplink transmission. Meanwhile, the first base station 104A sends 704 a request 404 to the backhaul network 202 to reserve resources 606 for the incoming data. The request 404 may contain the expected arrival time of the message, the message size and expected resource size. The backhaul network 202 may forward the request 404 to the second base station 1048, indicating that a message is arriving for the second UE 1008. The second base station 104B may provide radio resources 612 for the incoming data, and send 706 the DCI 610 as early as possible, whereupon the downlink grant is transmitted 710. Without the described example embodiment, the DCI 620 would be transmitted much later. This gives the opportunity to the second base station 104B for better scheduling. In addition, the transmission of the early DCI 610 may achieve a higher communication reliability. For instance, the DCI 610 may be transmitted multiple times, using different slots, to achieve high success probability of detecting the DCI 610. Another option is to request for an ACK in response to the early DCI 610, indicating that the second UE 100B has received the DCI 610 successfully and is ready for receiving the data with the reserved radio resources 612. After the reservations, the uplink data is received 712 using the uplink radio resources 604 by the first base station 104A, forwarded 714 via the backhaul 202 resources 608, and transmitted 716 by the second base station 104B using the downlink resources 612.

In an example embodiment, the means of the apparatus 300 are configured to cause the apparatus 300 to detect 402 the need by detecting 426 the scheduling request 600 from the first user apparatus 100A.

In an example embodiment, the means of the apparatus 300 are configured to cause the apparatus 300 to, in response to detecting 402 the need, request 406 radio resources 200B for an initial transmission from the second base station 104B to the second user apparatus 100B by triggering 428 transmission of downlink control information as early as possible to the second user apparatus 1008 in order to reserve the radio resources.

In an example embodiment, the means of the apparatus 300 are configured to cause the apparatus 300 to trigger 428 transmission of the downlink control information for a plurality of times 430 to the second user apparatus 1008.

In an example embodiment, the means of the apparatus 300 are configured to cause the apparatus 300 to trigger 428 transmission of the downlink control information for the plurality of times 430 using different time slots 432.

In an example embodiment, the means of the apparatus 300 are configured to cause the apparatus 300 to trigger 428 transmission of the downlink control information so that an acknowledgement is requested 434 from the second user apparatus 1008.

Even though the invention has been described with reference to one or more example embodiments according to the accompanying drawings, it is clear that the invention is not restricted thereto but can be modified in several ways within the scope of the appended claims. All words and expressions should be interpreted broadly, and they are intended to illustrate, not to restrict, the example embodiments. It will be obvious to a person skilled in the art that, as technology advances, the inventive concept can be implemented in various ways.

1. An apparatus comprising circuitry configured for causing the apparatus at least to perform:
detecting a need for a transmission of data from a first user apparatus via a first base station to a second user apparatus via a second base station;
in response to detecting the need, requesting backhaul resources for a transmission from the first base station to the second base station; and
after requesting the backhaul resources, controlling reception of the data from the first user apparatus, and triggering a transmission of the data using the backhaul resources to the second base station for a transmission of the data to the second user apparatus.

2. The apparatus of claim 1, wherein the circuitry is configured to cause the apparatus to perform:
defining an expected point in time when the data for the transmission is ready; and
requesting the backhaul resources based on the expected point in time.

3. The apparatus of claim 1, wherein the circuitry is configured to cause the apparatus to perform:
defining an expected size of the data for the transmission; and
requesting the backhaul resources based on the expected size.

4. The apparatus of claim 1, wherein the circuitry is configured to cause the apparatus to perform:
detecting the need by detecting a failed initial transmission of the data.

5. The apparatus of claim 4, wherein the circuitry is configured to cause the apparatus to perform:
in response to detecting the need, triggering a retransmission procedure of the data, and requesting the backhaul resources so that backhaul resources which have been reserved before detecting the need are used for requesting retransmission backhaul resources and retransmission radio resources for a retransmission so that radio resources which have been reserved before detecting the need are used for transmitting downlink control information to the second user apparatus in order to reserve the retransmission radio resources; and
after requesting the retransmission backhaul resources, controlling reception of the data from the first user apparatus as a retransmission of the data, and triggering the transmission of the data as a retransmission of the data using the retransmission backhaul resources to the second base station for the transmission of the data as a retransmission of the data using the retransmission radio resources to the second user apparatus.

6. The apparatus of claim 1, wherein the circuitry is configured to cause the apparatus to perform:
detecting the need by detecting a scheduling request from the first user apparatus.

7. The apparatus of claim 6, wherein the circuitry is configured to cause the apparatus to perform:
in response to detecting the need, requesting radio resources for an initial transmission from the second base station to the second user apparatus by triggering transmission of downlink control information as early as possible to the second user apparatus in order to reserve the radio resources.

8. The apparatus of claim 7, wherein the circuitry is configured to cause the apparatus to perform:
triggering transmission of the downlink control information for a plurality of times to the second user apparatus.

9. The apparatus of claim 8, wherein the circuitry is configured to cause the apparatus to perform:
triggering transmission of the downlink control information for the plurality of times using different time slots.

10. The apparatus of claim 7, wherein the circuitry is configured to cause the apparatus to perform:
triggering transmission of the downlink control information so that an acknowledgement is requested from the second user apparatus.

11. The apparatus of claim 1, wherein the circuitry is configured to cause the apparatus to perform:
in response to detecting the need, requesting radio resources for the transmission of the data from the second base station to the second user apparatus.

12. The apparatus of claim 1, wherein the apparatus is the first base station.

13. The apparatus of claim 1, wherein the circuitry comprises:
one or more processors; and
one or more non-transitory memories including computer program code, the one or more memories and the computer program code are configured to, with the one or more processors, cause the performance of the apparatus.

14. A method comprising:
detecting a need for a transmission of data from a first user apparatus via a first base station to a second user apparatus via a second base station;
in response to detecting the need, requesting backhaul resources for a transmission from the first base station to the second base station; and
after requesting the backhaul resources, controlling reception of the data from the first user apparatus, and triggering a transmission of the data using the backhaul resources to the second base station for a transmission of the data to the second user apparatus.

15. The method of claim 14, comprising:
defining an expected point in time when the data for the transmission is ready; and
requesting the backhaul resources based on the expected point in time.

16. The method of claim 14, comprising:
defining an expected size of the data for the transmission; and
requesting the backhaul resources based on the expected size.

17. The method of any preceding claim 14, comprising:
detecting the need by detecting a failed initial transmission of the data.

18. The method of claim 17, comprising:
in response to detecting the need, triggering a retransmission procedure of the data, and requesting the backhaul resources so that backhaul resources which have been reserved before detecting the need are used for requesting retransmission backhaul resources and retransmission radio resources for a retransmission so that radio resources which have been reserved before detecting the need are used for transmitting downlink control information to the second user apparatus in order to reserve the retransmission radio resources; and
after requesting the retransmission backhaul resources, controlling reception of the data from the first user apparatus as a retransmission of the data, and triggering the transmission of the data as a retransmission of the data using the retransmission backhaul resources to the second base station for the transmission of the data as a retransmission of the data using the retransmission radio resources to the second user apparatus.

19. The method of claim 14, comprising:
detecting the need by detecting a scheduling request from the first user apparatus.

20. The method of claim 19, comprising:
in response to detecting the need, requesting radio resources for an initial transmission from the second base station to the second user apparatus by triggering transmission of downlink control information as early as possible to the second user apparatus in order to reserve the radio resources.

21. The method of claim 20, comprising:
triggering transmission of the downlink control information for a plurality of times to the second user apparatus.

22. The method of claim 21, comprising:
triggering transmission of the downlink control information for the plurality of times using different time slots.

23. The method of claim 20, comprising:
triggering transmission of the downlink control information so that an acknowledgement is requested from the second user apparatus.

24. The method of claim 14 comprising:
in response to detecting the need, requesting radio resources for the transmission of the data from the second base station to the second user apparatus.

25. A non-transitory computer-readable medium comprising computer program code, which, when loaded into one or more processors and executed by the one or more processors, causes an apparatus to perform operations comprising:
detecting a need for a transmission of data from a first user apparatus via a first base station to a second user apparatus via a second base station;
in response to detecting the need, requesting backhaul resources for a transmission from the first base station to the second base station; and
after requesting the backhaul resources, controlling reception of the data from the first user apparatus, and triggering a transmission of the data using the backhaul resources to the second base station for a transmission of the data to the second user apparatus.
